(19) United States
(12) Patent Application Publication
(10) Pub. No.: US 2026/0316005 A1
(43) Pub. Date: Oct. 15, 2026

(54) Ultra Fine Air Purification System

(71) Applicant: John Combs, Greeenfield, IN (US)

(72) Inventor: John Combs, Greeenfield, IN (US)

(21) Appl. No.: 19/638,011

(22) Filed: Apr. 2, 2026

Related U.S. Application Data
(60) Provisional application No. 63/783,926, filed on Apr. 4, 2025.

(51) Int. Cl. B01D 53/75; B01D 46/00; B01D 46/42; B01D 46/54; B01D 46/58; B01D 46/62; B01D 53/00; B01D 53/04; B01D 53/86; B01D 53/88

(52) U.S. Cl. CPC B01D 53/75; B01D 46/0028; B01D 46/0032; B01D 46/0036; B01D 46/0038; B01D 46/0041; B01D 46/4236; B01D 46/54; B01D 46/58; B01D 46/62; B01D 53/007; B01D 53/0446; B01D 53/8687; B01D 53/885; B01D 2253/102; B01D 2255/20707; B01D 2255/802; B01D 2257/708; B01D 2257/91; B01D 2258/06; B01D 2259/4508; B01D 2259/455; B01D 2259/804; B01D 2271/02; B01D 2279/40

(57) ABSTRACT

An Ultra Fine Air Purification System (UFAP) which provides submicron to gaseous-phase air purification in a portable, low energy, and an aluminum honeycomb cabinet. The system has two parallel filtration assemblies with sequential stages: a MERV 8 carbon pre-filter for particulate and VOC adsorption; a MERV 12 electrostatic high-flow pre-filter for fine particulates; a primary submicron hyper-filter achieving high filtration efficiency; a Dual-Quad photocatalytic oxidation (PCO) filter array with UVC lamps, aluminum reflectors, and an aluminum honeycomb substrate with a titanium dioxide coating for destruction of bacteria, viruses, mold, and contaminants; a pressure-regulating activated carbon filter containing distinctly sized carbon granules; and a silver-impregnated post-filter for antimicrobial protection. Airflow is driven by electronically commutated fans that are low noise having levels as low as 56 decibels at maximum speed. The system achieves filtration efficiency approaching ULPA standards and is suitable for residential, commercial, medical, military, and maritime environments.

### CROSS-REFERENCE TO RELATED APPLICATIONS

This application claims the benefit of United States Provisional Patent Application with Ser. No. 63/783,926 filed Apr. 4, 2025, by John Combs and entitled “An Ultra Fine Air Purification System”.

### FIELD OF INVENTION

This invention relates to an Ultra Fine Air Purification Device. The present disclosure relates specifically to a type/kind of air cleaning systems and relates to a method for purifying air by separating particles and/or organic substances. The present invention relates to a system and a method for purifying air by separating particles and/or organic substances. This system relates to an air filtration and air purification device apparatus, and more specifically to an air filtration and air purification apparatus that provides six levels of air filtering to a volume of air.

### FEDERALLY SPONSORED RESEARCH

None.

### SEQUENCE LISTING OR PROGRAM

None.

### BACKGROUND-FIELD OF INVENTION and PRIOR ART

As far as known, there are no other Ultra Fine Air Purification Systems shown or taught.

Currently, there are many methods to clean the air of a room or an environment. Conventional methods include known filtering units which reside inside the room environment and filter the air. These known filtering units may be permanent or portable and will fitter the air of a room or area, filter the air continually as they operate, draw the air into the unit, filtering the air and then returning it to this same environment. An air purifier, also known as an air filtration system, helps improve indoor air quality by removing contaminants and pollutants. It is commonly used in homes, offices, and other indoor environments to create a healthier and more comfortable living or working space.

An air purifier acts as an air purification system for house, as it helps to eliminate dust, pollen, pet dander, mold spores, and other harmful particles that can cause allergies or respiratory problems. These devices are designed to filter the air and trap these pollutants, ensuring that the air one breathes is clean and free from harmful substances.
Air purification systems come in various sizes and types, with different features and technologies to suit different needs and preferences. Some air purifiers are specifically designed to target dust particles and are known as air purifiers for dust. These devices typically have a high-efficiency particulate air (HEPA) filter that can effectively capture and remove even the tiniest dust particles from the air.

Indoor air purifiers are devices designed to improve indoor air quality by removing harmful particles and pollutants from the air. Imagine these air cleaners for home as microscopic vacuum cleaners for a person's lungs. They work tirelessly, employing HEPA filters to trap dust and pollen, carbon filters to absorb harmful gases and odors, and UV light to neutralize bacteria and viruses. The result? Cleaner air that is easier to breathe, which is one of the main advantages of air purifiers. HEPA filters are highly efficient in removing airborne contaminants, making them a popular choice for those who suffer from allergies or asthma. Removing dust, allergens, and other pollutants from the air, these air purifier systems help to create a healthier and more comfortable indoor environment. The commercially graded air purifiers are manufactured as either small stand-alone units or larger units that can be affixed to an air handler unit (AHU) or to an HVAC unit found in the medical, industrial, and commercial industries. Air purifiers may also be used in industry to remove impurities from air before processing. Pressure swing adsorbers or other adsorption techniques are typically used for this.

Air purifiers have become essential in today's world to combat indoor air pollution and improve overall air quality. They operate using a multi-stage filtration process, each stage designed to capture specific types of contaminants.

The whole-home UV air purifier is the best choice compared to an ionizer due to its superior ability to neutralize harmful microorganisms like bacteria, viruses, and mold spores, which ionizers struggle to remove. Unlike ionizers, UV purifiers do not produce harmful ozone layers, ensuring safer indoor air. Dust, pollen, pet dander, mold spores, and dust mite feces can function as allergens, triggering allergies in sensitive people.

Smoke particles and volatile organic compounds (VOCs) can pose a risk to health. Exposure to various components such as VOCs increases the likelihood of experiencing symptoms of sick building syndrome.

In some embodiments, there is provided a low-noise, low-profile air cleaning device, namely an indoor air scrubbing or gas adsorption apparatus, comprising one or more inlets, a first outlet, a second outlet, dampers to control the outlets, one or more fans, a heater coil, a sorbent bank, and an electronic control circuit, that can operate in at least two modes: adsorption and regeneration, where in adsorption mode, air enters through one or more of the inlets and exits through a first outlet after passing through the sorbent bank, such that at least one type of gas species is partially captured by the sorbent upon passing through the bank. In regeneration mode, air enters through one or more of the inlets and exits through a second outlet, after passing through the heating coil and the sorbent bank, where the coil is heated, causing the release of at least one type of gas species. The outlet dampers, fans and heaters are controlled by the electronic control circuit to determine or schedule in which mode the device operates. In some embodiments, the deployment of the cabinet may comprise hanging the apparatus from at least one of a ceiling and a wall of the indoor area. In some embodiments, the apparatus may further comprise a filter configured for removing particulate matter from the air stream, wherein the filter is arranged to filter an airflow prior to or after being received by the sorbent bank. In some embodiments, the filter may comprise a plurality of cyclonic separators.

In recent years there has been a growing interest in improving environmental air conditions in homes and in commercial settings such as offices, restaurants, laboratories, hospitals and the like. As more information has been made available to the public concerning the hazards of indoor pollution, there has been an increased demand for filtering devices which can be used to effectively improve air quality.

### Problems Solved

Many problems are solved with the advent of an Ultra Fine Air Purification System. These include A better solution for odor control, volatile organic compounds (VOC) elimination, and air purification where high-efficiency particulate air (HEPA) level filtration is sufficient; Six (6) stage purification; effective baffling of air flow and specialized sound deadening materials that allow high throughput performance at incredibly low noise levels (as low as 56 dB at MAX power); Low energy consumption; High performance, pressure regulating carbon cylinders; Minimal footprint and on castors for easy movement within the room; Proprietary Dual-Quad Hellfire PCO arrays and filters designed to last the lifetime of the unit; and Extremely durable and rigid marine-grade, aluminum honeycomb core construction.

### PRIOR ART

A novelty search was completed for an Ultra Fine Air Purification System. The search revealed the following:
A. CN101469897B in 2017 for an Air Purification System. An air purification system including a Particle Phase Pollutant (PPP) treatment section having an air inlet and an air outlet, a particle removal filter, and a blower to draw air from the air inlet of the PPP treatment section to pass through the particle removal filter and exit through the air outlet of the PPP treatment section.
B. WO2007055430A1 by Bang in 2007 for Air Purifier with Sterilization, Deodorization and Absorbing Toxic Materials. An invention relates to an air purifying apparatus having functions of sterilization, deodorization, and removing the harmful materials.
C. U.S. Pat. No. 8,778,272B2 by Chan et al in 2014 Air Purification System. An air purification system including a Particle Phase Pollutant (PPP) treatment section.
D. E102016106281A1 by Vorwerk and Co in 2016 for Air Purifier and Method for Purifying Air by Separating Particles and Organic Matter. The invention relates to an air cleaner for purifying air by separating particles and/or organic substances, comprising a first fan device, a second fan device, a dust filter, a combination filter for separating dust particles and organic substances and with switching means for activating the first fan device and/or the second fan device.
E. U.S. Pat. No. 8,974,565B2 by Cecchi et al in 2015 for Air Filtration and Air Purification Apparatus. An air filtration and air purification apparatus.
F. U.S. Pat. No. 11,673,090B2 by Meirav et al., in 2023 for Low Noise, Ceiling Mounted Indoor Air Scrubber. An indoor air cleaning apparatus and a method for removing at least a portion of at least one type of gas from an indoor airflow are disclosed.
G. U.S. Pat. No. 5,348,563A by Davis in 1994 for Air Purifying Apparatus. A ceiling mounted air purifier that provides a high velocity, multi-directional air exhaust pattern that distributes filtered air to all areas of a room which includes a plurality of filters and centrifugal fans. The centrifugal fans are substantially surrounded by baffles which form generally equally spaced exhaust outlets.
H. U.S. Pat. No. 9,266,118B2 by Iwaki in 2016 for Air Purifier. An air purifier capable of increased air purification properties due to charged particles being blown out. A first air-blower blasts air, thus drawing air in from the outside to a first air-flow path, and an air-purification unit purifies the air and blows out same.
I. U.S. Pat. No. 10,821,389B2 by Bae et al., in 2020 for Air Purifier with Hinged Filter Frame.
   An air purifier may comprise: a housing; a blowing unit installed in the housing so as to draw in external air; and a filter unit having filtering surfaces, through which the air passes and which are disposed in multiple directions, and an air inflow space, which has at least a part thereof surrounded by the filtering surfaces disposed in the multiple directions and into which the air discharged from the blowing unit flows.
J. US20070137489A1 by Luo in 2007 for Air Purifier Having Sterilizing Function.
   An air purifier having sterilizing function, comprising a vertically standing main frame, a front cover provided with air outlets, a blower assembly installed inside the main frame, and a control panel provided on the main frame, wherein the main frame has air inlets, an inlet grille is provided at a position corresponding to the air inlets, and an outlet grille is provided at a position corresponding to the air outlets of the front cover, and wherein a sterilizing device is provided under the blower assembly.
K. U.S. Pat. No. 9,101,866B2 by Miller in 2015 for Room Air Purifier. A room air purifier is provided that has a housing that defines a floor supply duct inlet, a room air inlet, and an outlet. An air mixing chamber within the housing is in direct communication with said room air inlet and said floor supply duct inlet. A filter is disposed in the housing. A fan is disposed in said housing between the outlet of the filter and the outlet side of the filter.
L. U.S. Pat. No. 9,737,841B2 by Law in 2017 for Air Purification System. A method for air purification is disclosed, comprising directing air through a particle removal filter that acts to filter the air for particle phase pollutants to thereby produce particulate filtered air; and directing an amount of the particulate filtered air through a gas removal filter that acts to filter the particulate filtered air for gas phase pollutants to thereby produce gas filtered air; the particle removal filter with the first blower and the gas removal filter with the second blower are housed in different enclosures and they are allowed to operate in that way.
M. U.S. Pat. No. 7,063,820B2 by Goswami in 2006 for Photoelectrochemical Air Disinfection. A system for disinfecting a fluid containing microorganisms or chemical contaminants includes a plurality of photocatalyst surfaces secured to a solid surface upon which a fluid to be disinfected contacts. A structure for removing a portion of the photogenerated electrons is in electrical contact with the photocatalyst layer, wherein an electron-hole recombination rate involving the photogenerated electrons and holes is reduced, thus increasing the removal rate of microorganisms or chemical contaminants from the fluid.
N. US20170082305A1 by Law in 2017 for An Air Purification Device. An air purification device comprising: air flow path adjuster (10) and a primary filter (30), the said air flow path adjuster (10) able to change the path of the air flow within the air cleaning device, so that to enable the air bypassing or passing through said primary filter (30). The air purification device can improve air cleaning efficiency.
O. FR3084735B1 by Paolo e al., in 2018 AIR PURIFICATION UNIT AND ASSOCIATED OPERATING PROCEDURE. An air purification assembly.
P. U.S. Pat. No. 11,421,901B2 by Morgan et al., in 2022 for Coordinated Control of Standalone and Building Indoor Air Quality Devices and Systems. The first and second IAQ sensors are located within a building and are configured to measure first and second IAQ parameters, respectively, the first and second IAQ parameter being the same one of: relative humidity; amount of particulate; amount of volatile organic compounds; and amount of carbon dioxide.

As can be observed, none of the prior art has anticipated or caused one skilled in the technology of air purification systems and a combination of components to make such purification systems to see this unique combination. This system is not considered as obvious to one skilled in the industry for systems and one skilled with components and devices for use in air purification systems when a person is innovating a new or better air purification system and sike systems.

### SUMMARY OF THE INVENTION

The Ultra Fine Air Purification System is a submicron air purifier system that is designed and built based on clinical and Department of Defense air purification requirements. This is accomplished by using highly advanced technologies and components. A preferred embodiment as an Ultra Fine Air Purification System having at least two/a pair/dual filtration components with submicron hyper-filter components and six (6) stages of filtration per side comprising: (a) a cabinet Ultra Fine Air Purification System, the cabinet made of durable materials such as 5150 Marine Grade Aluminum Honeycomb, stainless steel, other durable metals with corrosion resistant coatings, composite materials configured with air inlet and exit panels, maintenance panels and casters and having a power source and electrical controls; (b) an air movement system comprised of Electronically Communicated (EC) Fans, lower transition ducts connecting EC fans to the lower PCO filter, upper transition ducts connecting EC fans to the upper silencer wherein the six (6) stages of filtration per side are comprised of a set of dual pre-filters with MERV 8 and MERV 12 ratings, a primary filter, a PCO filter, a PCO filter with a high output (>50 Watt) T-5 UVC bulbs and with a proprietary lifetime Titanium Dioxide (TiO2) coating over aluminum honeycomb of the PCO filter, and a carbon filter with at least three sizes of granules.

### Objects and Advantages

There are several objects and advantages of an Ultra Fine Air Purification Systems. These various advantages, benefits, and characteristics for air purification systems include:

| Item | Advantage |
|---|---|
| 1 | A great solution for odor control, volatile organic |
| | compounds (VOC) elimination, and air purification |
| | where HEPA level filtration is sufficient |
| 2 | Proprietary, individually tested and certified hyper- |
| | Filter technology, providing an incredible ~99.999% |
| | efficiency rating |
| 3 | Six (6) stage purification |
| 4 | Proprietary baffling and specialized sound deadening |
| | materials that allow high throughput performance at |
| | incredibly low noise levels (as low as 56 dB at MAX |
| | power) |
| 5 | High performance, pressure regulating carbon |
| | cylinders |
| 6 | Low energy consumption |
| 7 | Minimal footprint and on castors for easy movement |
| | within the room |
| 8 | Multiple range of unit performance and sizes |
| 9 | Dual HEPA filters |
| 10 | Proprietary Dual-Quad Hellfire PCO arrays and filters |
| | designed to last the lifetime of the unit |
| 11 | Ten (10)-speed EC fans |
| 12 | Extremely durable and rigid marine-grade, aluminum |
| | honeycomb core construction |

Finally, other advantages and additional features of the present Ultra Fine Air Purification Systems will be more apparent from the accompanying drawings and from the full description of the device. For one skilled in the art of designing and using accessories and components for air purification, it is readily understood that the features shown in the examples with this system can be adapted to other types of air purification systems, devices, and accessories.

### DESCRIPTION OF THE DRAWINGS—FIGURES

The accompanying drawings, which are incorporated in and constitute a part of this specification, illustrate an embodiment of an Ultra Fine Air Purification System that is preferred for optimum air purification. The drawings together with the summary description given above and a detailed description given below help to explain the principles of the Ultra Fine Air Purification System. It is understood, however, that this air purification system is not limited to only the precise arrangements and instrumentalities shown.

FIGS. 1 A through 1 C are sketches portraying an overview of the Ultra Fine Air Purification System 30 and the manner to use such a system when desiring improved air purification.

FIGS. 2 A through 2 G are sketches of a pre-filter, main filter, a component using photocatalytic oxidation (PCO), a carbon filter, EC 10 fans, and a pair of silencers for an Ultra Fine Air Purification System.

FIGS. 3 A through 3 C are more sketches of an Ultra Fine Air Purification System (UFAP) showing the internal stack-up of components for air movement including the carbon filters, transition components from the carbon filter to a pair of EC 10 fans or air movers, more transitions, and matching silencers. This internal stack-up of air movement components is interposed and fit internally to a group of other filter components and the structural enclosure for the UFAP System.

FIGS. 4 A through 4 C are sketches of the Ultra Fine Air Purification System and the components in use with the UFAP System. These sketches are from the front, side and top positions.

FIGS. 5 A through 5 C are sketches of the Dual-Quad Hellfire PCO phased arrays and carbon filter. The Photocatalytic Oxidation (PCO) array is shown in relationship to the other filter components and structure of the Ultra Fine Air Purification System.

FIGS. 6 A through 6 F are sketches of a structure containing the components for the Ultra Fine Air Purification System. These sketches are shown from the front, side and back views plus three sectional sketches for the bottom, middle and upper sections of the cabinet structure.

FIGS. 7 A through 7 E are more inside sketches of the UFAP system showing the internal opening or space where the carbon and PCO filters are located. This is the stack-up of the carbon filters, transitional ducting, E 10 fans and silencers for the Ultra Fine Air Purification System.

FIGS. 8 A through 8 D are more sketches of an Ultra Fine Air Purification System and the relationship of the containment structure and the filter system. These sketches show the corners, angles, and openings of the overall Ultra Fine Air Purification System and how the vertical stack of the carbon filter, EC 10 fans, and silencers are placed or interposed between the other filters and components.

FIGS. 9 A through 9 F are sketches of the various typical filters and controllers placed into a unique combination so that the Ultra Fine Air Purification System can achieve outstanding purification of the surrounding air.

FIGS. 10 A through 10 F are sketches of typical pre-filters, main or primary HEPA filters, PCO arrays, granular carbon filters, and post filters. This combination of these filters, when placed in the containment structure, provides a new and unique combination system for air purification. The results achieved, when using the Ultra Fine Air Purification System taught by inventor John Comb, demonstrate significant reduction or elimination of hazardous materials from the surrounding air and demonstrate superior air quality for the treated air.

FIGS. 11 A through 11 D are sketches of test indicators for reduction or elimination of targeted hazardous materials. Results found that when the air is treated by the Ultra Fine Air Purification System, favorable reduction or elimination of the targeted hazardous materials is achieved.

FIG. 12 is a sketch portraying the size and growth of the global market emerging for air purifier devices and air purification systems.

FIGS. 13 A through 13 H are sketches of prior art for air purification devices and systems.

### DESCRIPTION OF THE DRAWINGS—REFERENCE NUMERALS

The following list refers to the drawings:

TABLE B
Reference numbers -

| Ref # | Description |
|---|---|
| 30 | Ultra Fine Air Purification System 30, an air purification |
| | system having at least two/a pair/and dual filtration |
| | components with submicron hyper-filter components and six |
| | (6) stages of filtration per side, a SUBMICRON hyper- |
| | Filter |
| 31 | Global Market Chart 31 of air purifiers |
| 35 | Inline stack-up 35 of PCO filter 70, Electronically |
| | Communicated (EC) Fans 90, lower transition ducts 91 |
| | connecting EC fans 90 to the lower PCO filter 70, upper |
| | transition ducts 92 connecting EC fans 90 to the upper |
| | silencer 80 |
| 40 | Cabinet 40 Ultra Fine Air Purification System 30, the |
| | cabinet made of durable materials such as 5150 Marine |
| | Grade Aluminum Honeycomb, stainless steel, other durable |
| | metals with corrosion resistant coatings, composite |
| | materials such as polymers with reinforcing carbon fiber |
| | and/or steel wire mesh for improved stiffness, strength, |
| | and ductility with optional surface preparation such as |
| | powder coating) |
| 40A | Apertures/clearance 40A in a horizontal partition 44A of |
| | the cabinet 40 for carbon filters 80 |
| 40B | Apertures/clearance 40B in a horizontal partition 44B of |
| | the cabinet 40 for various filters (pre-filter 50, primary |
| | filter 60, PCO filter 70, and carbon filter 80 |
| 41 | Access panels 41 for maintenance, repair, and exchange of |
| | filters |
| 42 | Air inlet panels 42 on either side and bottom section of |
| | the cabinet 40 |
| 43 | Protection screens 43 on each access panel 41 |
| 44 | Lowest horizontal partition/floor 44 of the cabinet 40 |
| | with an external surface 44-S |
| 44A | horizontal partition 44A of the cabinet 40 adjacent to the |
| | carbon filters 80 |
| 44B | horizontal partition 44B of the cabinet 40 adjacent to the |
| | various filters (pre-filter 50, primary filter 60, PCO |
| | filter 70, and carbon filter 80 |
| 44C | Highest/top horizontal partition 44C of the cabinet 40 |
| | with an external surface 44C-S |
| 45 | Air Outlet panel 45 for purified air to exit the |
| | purification system 30 from the silencer 95 at a top |
| | location of the cabinet 40 |
| 46 | Caster/wheels or the like 46 with an attachment structure |
| | 47 to secure the caster 46 to the external surface 44-S of |
| | the floor 44 of the cabinet 40 |
| 47 | Structural components 47 of the cabinet 40 including |
| | corners, edge members, fastening means (weld, braze, |
| | threaded fasteners, pop rivets etc. |
| 50 | Pre-filter 50, a MERV 8 carbon pre-filters as a first |
| | level of defense also providing a level of VOC absorption, |
| | a minimum efficiency reporting value (MERV) is a rating |
| | system that measures how well an air filter traps |
| | particles in the air |
| 50A | First filter media 50A for the pre-filter 50, with a |
| | specification - a MERV 8 carbon pre-filter as a first |
| | level of defense and providing a level of VOC absorption; |
| | MERV 8 filters have 90 percent efficiency on particles |
| | that are 3 to 10 micrometers in size. MERV 1 to 4 - |
| | effective at controlling larger particles such as, sanding |
| | dust, spray paint dust, lint and carpet fibers |
| 50B | Alternative filter media 50B for the pre-filter 50, with a |
| | specification - a MERV 12 electrostatic high-flow pre- |
| | filters are as a second or alternative level of defense; |
| | MERV 12 is an air filter rating that can trap up to 89% of |
| | particles that are 3.0-10.0 microns in size, and 80-90% of |
| | particles that are 1.0-3.0 microns in size. MERV 12 |
| | filters are often used in homes and hospitals, and are |
| | ideal for people with allergies or homes with pets |
| 50C | Perimeter structure 50C of the pre-filter 50 as a means |
| | for retaining the pre-filter media 50A |
| 51 | Retention component 51 as a means for retaining pre-filter |
| | media 50A and to interface the pre-filter 50 with the |
| | cabinet 40 |
| 53 | means for removing 53 the pre-filter 50 from the cabinet |
| | 40 such as angle iron, Tee structures, Cee channels, and |
| | the like |
| 60 | Main/primary filter 60 |
| 60A | main filter media 60A for the main filter 60 whereby when |
| | the media 60A exceeds “high efficiency particulate air |
| | [filter] [HEPA); a true HEPA filter or the |
| | proprietary hyper-Filters are capable of near ULPA level |
| | performance ULPA level performance at a staggering 99.999% |
| | efficiency, while still maintaining HEPA filter flow rates |
| 60B | Perimeter structure 60B of the main filter 60 as a means |
| | for removing the main filter media 60A to the main filter |
| | 60 |
| 61 | Retention component 61 as a means for retaining main |
| | filter media 60A and to interface with the cabinet 40 |
| 62 | protective powder coated screens 62 on each side of main |
| | filter media 60A |
| 63 | means for removably containing 63 the main filter 50 from |
| | the cabinet 40 such as angle iron, Tee structures, Cee |
| | channels, and the like |
| 64 | Dovetailed gaskets 64 made of Poron |
| 70 | photocatalytic oxidation (PCO) filter 70 |
| 71 | Electrical components and circuitry connections, |
| | installation of cables (conductors), switches, sockets, and |
| | other control devices 71 to provide power to the PCO bulbs |
| | as well as to provide power and controls to the EC fans 90 |
| | and any control devices in the system 30 |
| 73 | high density, high reflectivity German aluminum reflectors |
| | 73 |
| 74 | Means 74 for removably containing the PCO filter 70 such |
| | as angle iron, Tee structures, Cee channels, and the like |
| 75 | High output (>50 Watt) T-5 UVC bulbs 75 |
| 76 | aluminum honeycomb 76 for the PCO filters 70 |
| 77 | proprietary lifetime Titanium Dioxide (TiO2) coating 77 |
| | over aluminum honeycomb 76 of the PCO filter 70 |
| 80 | Carbon media filter 80 with an external and internal wire |
| | mesh holding granulated carbon media for the air to flow |
| | through engaged said carbon |
| 81 | Means 81 to connect carbon filter 80 to cabinet 40 such as |
| | threaded fasteners, slots and rod, cable ties, |
| 82 | Relatively large-sized carbon granules 82 (need size or |
| | range of sizes of the granules) |
| 82A | Relatively medium-sized carbon granules 82A (need |
| | size) (sized between 82 and 82B |
| 82B | Relatively small-sized carbon granules 82B (need size) |
| 83 | Means to connect 83 the carbon filter 80 to the lower |
| | transition 91 |
| 85 | Silver impregnated post filter 85 |
| 90 | Electronically Communicated (EC-10) Fans 90 or equal |
| 91 | Lower transition ducting 91 removably connecting the lower |
| | PCO filter 70 to the EC fans 90 |
| 92 | Upper transition ducting 92 removably connecting the EC |
| | fans 90 to the silencer 95 |
| 95 | silencer 95 for air movement and EC-10 fans 90 |
| 86 | Flexible duct 98 from outlet of silencer 95 to an outlet |
| | panel 45 |
| 99 | A means 99 to connect duct 98 to outlet panel 45 such as |
| | radiator clamps, screws, cable ties, sealants/adhesive or |
| | the like |
| 100 | |
| 105 | Temtop air quality meter 105 |
| 120 | Optional humidifier 120 |
| 125 | Optional dehumidifier 125 |
| 130 | Optional scent distributor 130 |
| 700 | Prior Art 700 - U.S. Pat. 9,266,118 by Iwaki in 2008 |
| | for an Air Purifier |
| 710 | Prior Art 710 - German Patent DE 10 2016 106 281 A1 |
| | by Vorwerk et al. in 2016 for an Air purifier and method |
| | for purifying air by separating particles and organic |
| | material |
| 720 | Prior Art 720 - International and Korean Patent |
| | PCT/KR2005/003756 by Bang in 2007 for an Air purifier with |
| | sterilization, deodorization and absorbing toxic |
| | materials. |
| 730 | Prior Art 730 - US Patent Application US2017/0082305 and |
| | PCT/CN2015/074373 by Law in 2017 for an Air Purifier with |
| | Sterilization, Deodorization and Absorbing Toxic Materials |
| 740 | Prior Art 740 - U.S. Pat. 9,737,841 by Luo in 2007 for |
| | an Air Purifier having sterilizing Function |
| 750 | Prior Art 750 - U.S. Pat. 8,778,272 by Chan in 2014 |
| | for an Air Purification System |
| 760 | Prior Art 760 - U.S. Pat. 11,673,090 by Meirav et al. |
| | in 2023 for an air flow system featuring LOW NOISE, |
| | CEILING MOUNTED INDOOR AIR SCRUBBER |
| 770 | Prior Art 770 U.S. Pat. 8,974,565 by Cecchi et al. in |
| | 2017 |

### DETAILED DESCRIPTION OF PREFERRED EMBODIMENT

This invention relates to an Ultra Fine Air Purification System 30. The present disclosure relates specifically to a kind of air cleaning system and relates to a method for purifying air by separating particles and/or organic substances. The present invention relates to a system and a method for purifying air by separating particles and/or organic substances. This system relates to an air filtration and air purification device apparatus, and more specifically to an air filtration and air purification apparatus that provides six levels of air filtering to a volume of air.

The advantages of an Ultra Fine Air Purification System 30 are:
A. A great solution for odor control, VOC elimination, and air purification where HEPA level filtration is sufficient;
B. Proprietary, individually tested and certified hyper-Filter technology, providing an incredible ~99.999% efficiency rating;
C. Six (6) stage purification;
D. Proprietary baffling and specialized sound deadening materials that allow high throughput performance at incredibly low noise levels (as low as 56 dB at MAX power);
E. High performance, pressure regulating carbon cylinders;
F. Relatively low energy consumption as compared with other air purification devices and systems;
G. Minimal footprint and on castors for easy movement within the room;
H. Multiple ranges of unit performance and sizes;
I. Dual HEPA filters;
J. Proprietary Dual-Quad Hellfire PCO arrays and filters designed to last the lifetime of the unit;
K. Ten (10)-speed EC fans; and
L. Extremely durable and rigid marine-grade, aluminum honeycomb core construction.

The preferred embodiment as an Ultra Fine Air Purification System 30 having at least two/a pair/dual filtration components with submicron hyper-filter components and six (6) stages of filtration per side comprising: (a) a cabinet 40 Ultra Fine Air Purification System 30, the cabinet made of durable materials such as 5150 Marine Grade Aluminum Honeycomb, stainless steel, other durable metals with corrosion resistant coatings, composite materials configured with air inlet and exit panels, maintenance panels and casters and having a power source and electrical controls; (b) an air movement system comprised of Electronically Communicated (EC) Fans 90, lower transition ducts 91 connecting EC fans 90 to the lower PCO filter 70, upper transition ducts 92 connecting EC fans 90 to the upper silencer 95 wherein the six (6) stages of filtration per side are comprised of a set of dual pre-filters 50 with MERV 8 and MERV 12 ratings, a primary filter 60, a PCO filter 70, a PCO filter 70 with a high output (>50 Watt) T-5 UVC bulbs 75 and with a proprietary lifetime Titanium Dioxide (TiO2) coating 77 over aluminum honeycomb 76 of the PCO filter 70, and a carbon filter 80 with at least three sizes of granules.

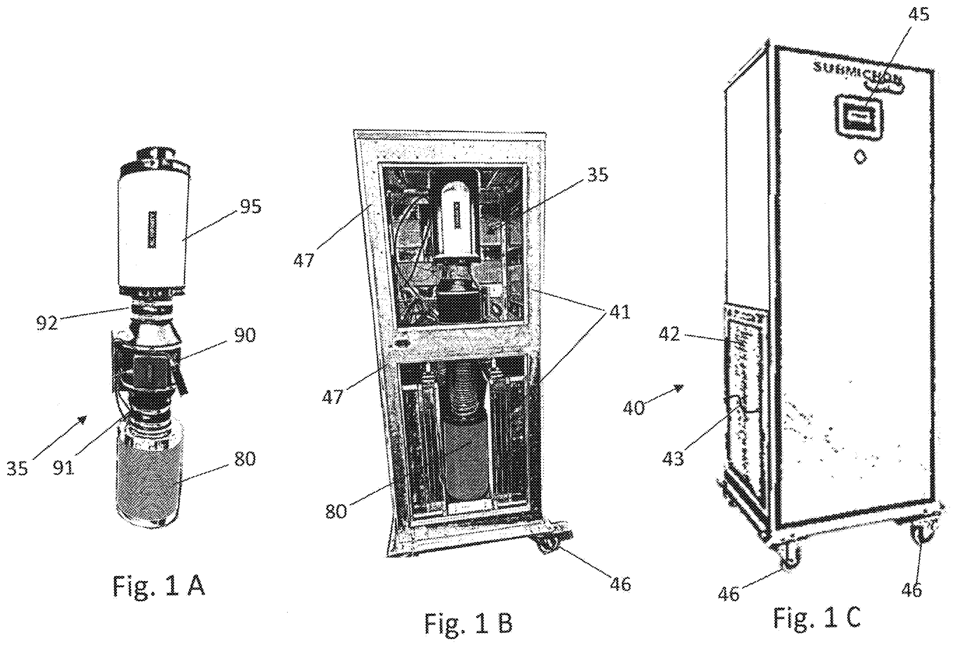

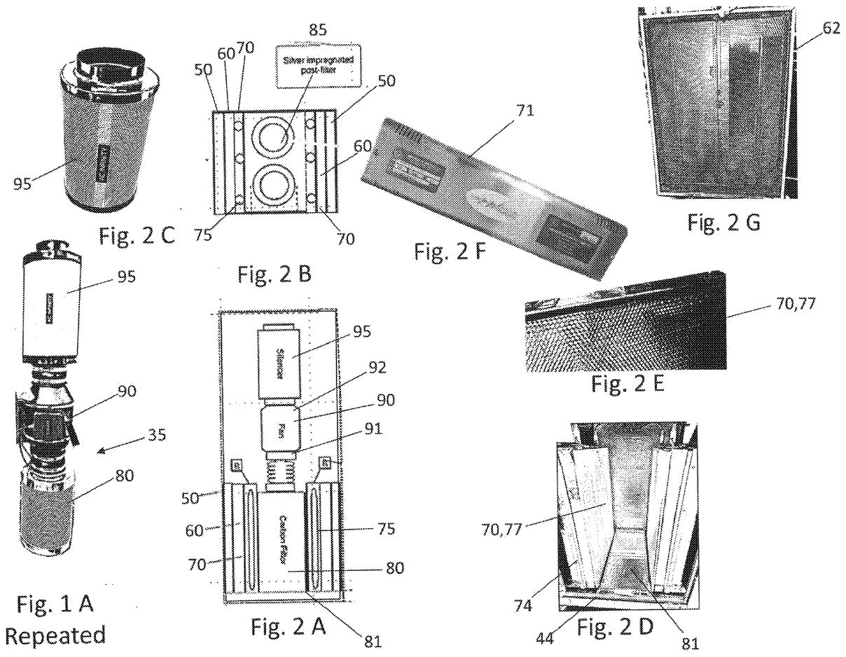

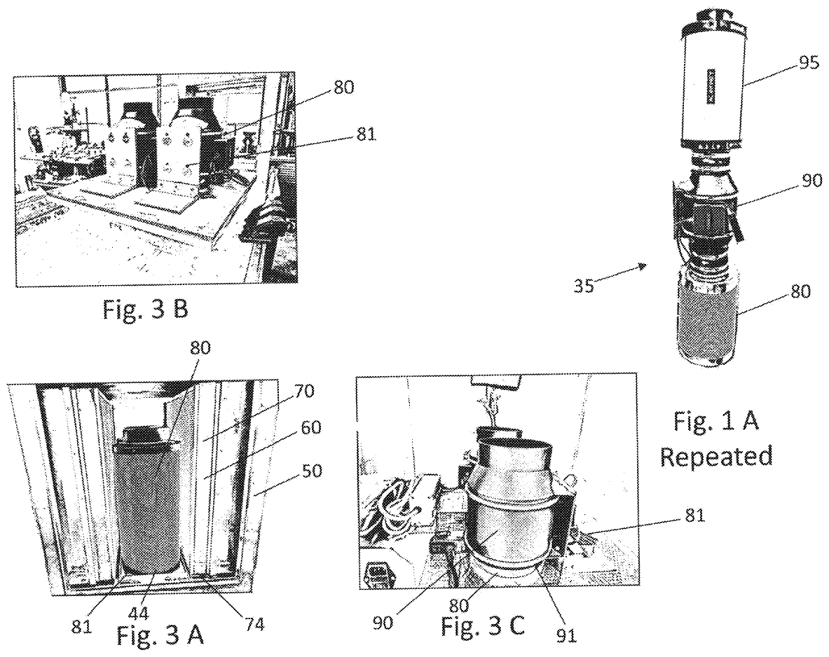

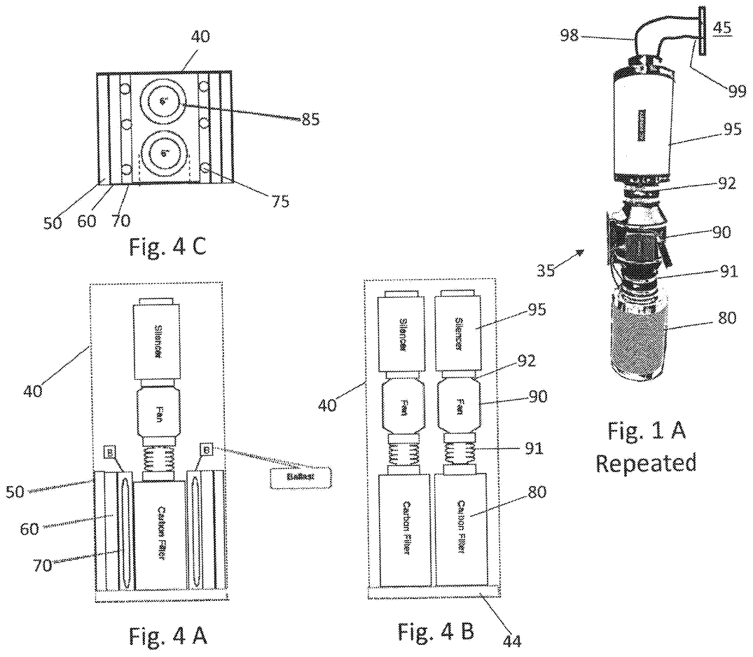

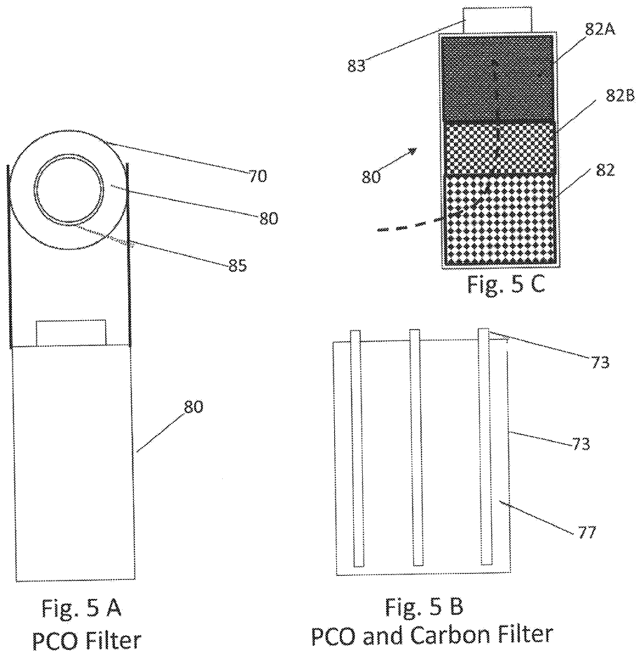

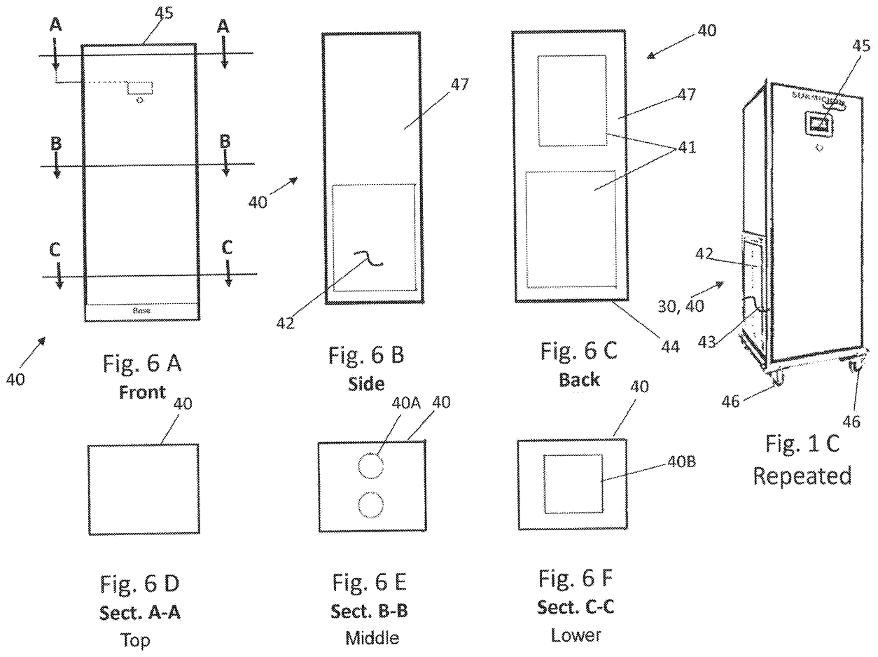

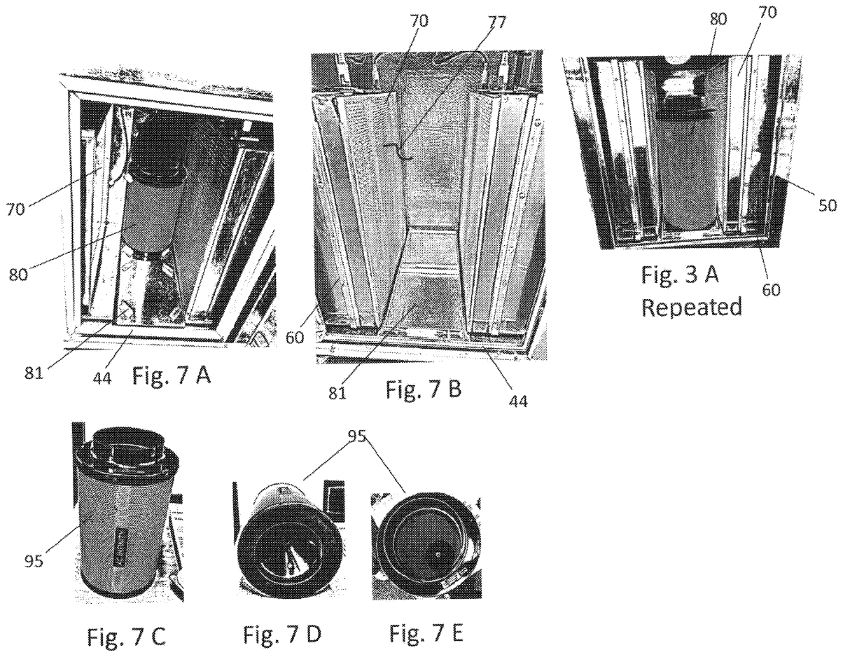

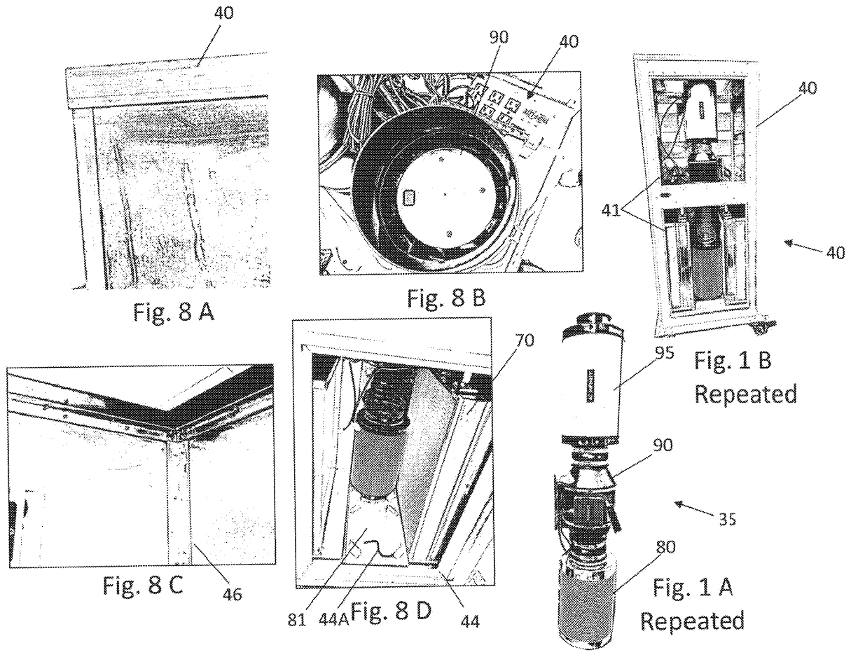

There is shown in FIGS. 1-13 a complete description and operative embodiment of the Ultra Fine Air Purification System 30, an air purification system having at least two/a pair/and dual filtration components with submicron hyper-filter components and six (6) stages of filtration per side, a SUBMICRON hyper-Filter. In the drawings and illustrations, one notes well that FIGS. 1-13 demonstrate the general configuration and use of this Ultra Fine Air Purification System 30, an air purification system having at least two/a pair/and dual filtration components with submicron hyper-filter components and six (6) stages of filtration per side, a SUBMICRON hyper-Filter, and the surrounding system. The operation and use section, provided below, describes how the Ultra Fine Air Purification System 30 is operated. The accompanying drawings, which are incorporated in and constitute a part of this specification, illustrate an embodiment of the Ultra Fine Air Purification System 30 and its use. The drawings together with the summary description given above and a detailed description given below serve to explain the principles of the Ultra Fine Air Purification System 30. It is understood, however, that system 30 is not limited to only the precise arrangements and instrumentalities shown. Other examples for using this Ultra Fine Air Purification System 30 are still understood by one skilled in the art of purifying indoor air quality transportation of goods, preparing and strapping the goods in place, and now installing the load with an alert system are anticipated to be within the scope and spirit shown here.

FIGS. 1 A through 1 C are sketches portraying an overview of the Ultra Fine Air Purification System 30 and the manner to use such a system when desiring improved air purification. The overview drawings show the following: an Ultra Fine Air Purification System 30, an air purification system having at least two/a pair/and dual filtration components with submicron hyper-filter components and six (6) stages of filtration per side, a SUBMICRON hyper-Filter; an inline stack-up 35 of PCO filter 70, Electronically Communicated (EC) Fans 90, lower transition ducts 91 connecting EC fans 90 to the lower PCO filter 70, upper transition ducts 92 connecting EC fans 90 to the upper silencer 80; a cabinet 40 Ultra Fine Air Purification System 30, the cabinet made of durable materials such as 5150 Marine Grade Aluminum Honeycomb, stainless steel, other durable metals with corrosion resistant coatings, composite materials such as polymers with reinforcing carbon fiber and/or steel wire mesh for improved stiffness, strength, and ductility with optional surface preparation such as powder coating); a set of access panels 41 for maintenance, repair, and exchange of filters; an air inlet panels 42 on either side and bottom section of the cabinet 40; a set of protection screens 43 on each access panel 41; an air Outlet panel 45 for purified air to exit the purification system 30 from the silencer 95 at a top location of the cabinet 40; a set of caster/wheels 46 and the like with an attachment structure 47 to secure the caster 46 to the external surface 44-S of the floor 44 of the cabinet 40; a group of structural components 47 of the cabinet 40 including corners, edge members, fastening means (weld, braze, threaded fasteners, pop rivets etc.; a carbon media filter 80 with an external and internal wire mesh holding granulated carbon media for the air to flow through engage said carbon; a pair of electronically Communicated (EC-10) Fans 90 or equal; a lower transition ducting 91 removably connecting the lower PCO filter 70 to the EC fans 90; an upper transition ducting 92 removably connecting the EC fans 90 to the silencer 95; and a silencer 95 for air movement and EC-10 fans 90.

FIGS. 2 A through 2 G are sketches of a pre-filter 50, main filter 60, a component using photocatalytic oxidation (PCO) 70, a carbon filter 80, EC 10 fans 90, and a pair of silencers 95 for an Ultra Fine Air Purification System 30. Portrayed and explained here are: an Ultra Fine Air Purification System 30, an air purification system having at least two/a pair/and dual filtration components with submicron hyper-filter components and six (6) stages of filtration per side, a SUBMICRON hyper-Filter; an inline stack-up 35 of PCO filter 70, Electronically Communicated (EC) Fans 90, lower transition ducts 91 connecting EC fans 90 to the lower PCO filter 70, upper transition ducts 92 connecting EC fans 90 to the upper silencer 80; a cabinet 40 Ultra Fine Air Purification System 30, the cabinet made of durable materials such as 5150 Marine Grade Aluminum Honeycomb, stainless steel, other durable metals with corrosion resistant coatings, composite materials such as polymers with reinforcing carbon fiber and/or steel wire mesh for improved stiffness, strength, and ductility with optional surface preparation such as powder coating); a set of access panels 41 for maintenance, repair, and exchange of filters; a pair of air inlet panels 42 on either side and bottom section of the cabinet 40; a set of protection screens 43 on each access panel 41; a lowest horizontal partition/floor 44 of the cabinet 40 with an external surface 44-S; an air Outlet panel 45 for purified air to exit the purification system 30 from the silencer 95 at a top location of the cabinet 40; a set of caster/wheels 46 and the like with an attachment structure 47 to secure the caster 46 to the external surface 44-S of the floor 44 of the cabinet 40; a group of structural components 47 of the cabinet 40 including corners, edge members, fastening means (weld, braze, threaded fasteners, pop rivets etc.; a pre-filter 50, a MERV 8 carbon pre-filters as a first level of defense also providing a level of VOC absorption, a minimum efficiency reporting value (MERV) is a rating system that measures how well an air filter traps particles in the air; a first filter media 50A for the pre-filter 50, with a specification—a MERV 8 carbon pre-filters as a first level of defense and also providing a level of VOC absorption; MERV 8 filters have 90 percent efficiency on particles that are 3 to 10 micrometers in size. MERV 1 to 4—effective at controlling larger particles such as, sanding dust, spray paint dust, lint and carpet fibers; an alternative filter media 50B for the pre-filter 50, with a specification—a MERV 12 electrostatic high-flow pre-filters are as a second or alternative level of defense; MERV 12 is an air filter rating that can trap up to 89% of particles that are 3.0-10.0 microns in size, and 80-90% of particles that are 1.0-3.0 microns in size. MERV 12 filters are often used in homes and hospitals, and are ideal for people with allergies or homes with pets; a perimeter structure 50C of the pre-filter 50 as a means for retaining the pre-filter media 50A; a true HEPA filter 60 or the proprietary hyper-Filters are capable of near ULPA level performance ULPA level performance at a staggering 99.999% efficiency, while still maintaining HEPA filter flow rates; a protective powder coated screens 62 on each side of main filter media 60A; a photocatalytic oxidation (PCO) filter 70; an electrical components and connections of circuitry, installation of cables (conductors), switches, sockets, and other control devices 71 to provide power to the PCO bulbs as well as to provide power and controls to the EC fans 90 and any control devices in the system 30; a high density, high reflectivity German aluminum reflectors 73; a means 74 for removably containing the PCO filter 70 such as angle iron, Tee (‘T’) structures, Cee (‘C’) channels, and the like; a high output (>50 Watt) T-5 UVC bulbs 75; a proprietary lifetime Titanium Dioxide (TiO2) coating 77 over aluminum honeycomb 76 of the PCO filter 70; a carbon media filter 80 with an external and internal wire mesh holding granulated carbon media for the air to flow through engage said carbon; a means 81 to connect carbon filter 80 to cabinet 40 such as threaded fasteners, slots and rod, cable ties; hook and eye, snaps; a silver impregnated post filter 85; a pair of electronically Communicated (EC-10) Fans 90 or equal; a lower transition ducting 91 removably connecting the lower PCO filter 70 to the EC fans 90; an upper transition ducting 92 removably connecting the EC fans 90 to the silencer 95; and a pair of silencers 95 for air movement and EC-10 fans 90.

Six (6) Stage Purification SubMicron 6 stages:
1 Pre-filters MERV 8 carbon pre-filters are the first level of defense also providing a level of VOC absorption.
2 Pre-filters MERV 12 electrostatic high-flow pre-filters are the second level of defense.
3 Primary Filters True HEPA filters or the proprietary hyper-Filters which are capable of near ULPA level performance at a staggering 99.999% efficiency, while still maintaining HEPA filter flow rates.
4 Dual-Quad Hellfire PCO phased arrays. Photocatalytic Oxidation (PCO) is a powerful air purification technology that can destroy bacteria and viruses, as well as airborne pollutants.
5 Carbon filters, the high-grade carbon filters feature a proprietary blend of activated carbon, which further removes volatile organic compounds (VOC) pollutants from the air.
6 Post-Filters The post-filters include a layer of pure silver filaments for additional antimicrobial protection.

FIGS. 3 A through 3 C are more sketches of an Ultra Fine Air Purification System (UFAP) showing the internal stack-up of components for air movement including the carbon filters, transition components from the carbon filter to a pair of EC 10 fans or air movers, more transitions, and matching silencers. This internal stack-up of air movement components is interposed and fit internally to a group of other filter components and the structural enclosure for the UFAP System. These sketches portray the following: an Ultra Fine Air Purification System 30, an air purification system having at least two/a pair/and dual filtration components with submicron hyper-filter components and six (6) stages of filtration per side, a SUBMICRON hyper-Filter; a Global Market Chart 31 of air purifiers; an inline stack-up 35 of PCO filter 70, Electronically Communicated (EC) Fans 90, lower transition ducts 91 connecting EC fans 90 to the lower PCO filter 70, upper transition ducts 92 connecting EC fans 90 to the upper silencer 80; a lowest horizontal partition/floor 44 of the cabinet 40 with an external surface 44-S; a pre-filter 50, a MERV 8 carbon pre-filters as a first level of defense also providing a level of VOC absorption, a main/primary filter 60; a photocatalytic oxidation (PCO) filter 70; a means 74 for removably containing the PCO filter 70 such as angle iron, Tee (‘T’) structures, Cee (‘C’) channels, and the like; a high output (>50 Watt) T-5 UVC bulbs 75; a carbon media filter 80 with an external and internal wire mesh holding granulated carbon media for the air to flow through engage said carbon; a means 81 to connect carbon filter 80 to cabinet 40 such as threaded fasteners, slots and rod, cable ties; hook and eye, snaps; a silver impregnated post filter 85; a pair of electronically Communicated (EC-10) Fans 90 or equal; a lower transition ducting 91 removably connecting the lower PCO filter 70 to the EC fans 90; and a silencer 95 for air movement and EC-10 fans 90.

FIGS. 4 A through 4 C are sketches of the Ultra Fine Air Purification System 30 and the components in use with the UFAP System. These sketches are from the front, side and top positions. These sketches demonstrate: an Ultra Fine Air Purification System 30; an inline stack-up 35 of PCO filter 70, Electronically Communicated (EC) Fans 90, lower transition ducts 91 connecting EC fans 90 to the lower PCO filter 70, upper transition ducts 92 connecting EC fans 90 to the upper silencer 80; a cabinet 40 Ultra Fine Air Purification System 30, the cabinet made of durable materials; a lowest horizontal partition/floor 44 of the cabinet 40 with an external surface 44-S; an air Outlet panel 45 for purified air to exit the purification system 30 from the silencer 95 at a top location of the cabinet 40; a main/primary filter 60; a photocatalytic oxidation (PCO) filter 70; a high output (>50 Watt) T-5 UVC bulbs 75; a carbon media filter 80 with an external and internal wire mesh holding granulated carbon media for the air to flow through engage said carbon; a silver impregnated post filter 85; a pair of electronically Communicated (EC-10) Fans 90 or equal; a lower transition ducting 91 removably connecting the lower PCO filter 70 to the EC fans 90; an upper transition ducting 92 removably connecting the EC fans 90 to the silencer 95; a silencer 95 for air movement and EC-10 fans 90; a flexible duct 98 from outlet of silencer 95 to an outlet panel 45; and a means 99 to connect duct 98 to outlet panel 45 such as radiator clamps, screws, cable ties, sealants/adhesive or the like.

FIGS. 5 A through 5 C are sketches of the Dual-Quad Hellfire PCO phased arrays and carbon filter. The Photocatalytic Oxidation (PCO) array is shown in relationship to the other filter components and structure of the Ultra Fine Air Purification System. Here the sketches provide: a photocatalytic oxidation (PCO) filter 70; a set of high density, high reflectivity German aluminum reflectors 73; an aluminum honeycomb 76 for the PCO filters 70; a proprietary lifetime Titanium Dioxide (TiO2) coating 77 over aluminum honeycomb 76 of the PCO filter 70; a carbon media filter 80 with an external and internal wire mesh holding granulated carbon media for the air to flow through engage said carbon; a means 81 to connect carbon filter 80 to cabinet 40 such as threaded fasteners, slots and rod, cable ties; hook and eye, snaps; a relatively large-sized carbon granules 82 (need size or range of sizes of the granules); a relatively medium-sized carbon granules 82A (need size) (sized between 82 and 82B; a relatively small-sized carbon granules 82B (need size); a means to connect 83 the carbon filter 80 to the lower transition 91; and a silver impregnated post filter 85. The photocatalytic oxidation (PCO) filter 70 and the Titanium Dioxide (TiO2) coating 77 over aluminum honeycomb 76 provide a powerful air purification technology that can destroy bacteria and viruses, as well as airborne pollutants

FIGS. 6 A through 6 F and 1 C repeated are sketches of a structure containing the components for the Ultra Fine Air Purification System and a SUBMICRON hyper-Filter 30. These sketches are shown from the front, side and back views plus three sectional sketches for the bottom, middle and upper sections of the cabinet structure. Shown are: a cabinet 40 Ultra Fine Air Purification System 30, the cabinet made of durable materials such as 5150 Marine Grade Aluminum Honeycomb, stainless steel, other durable metals with corrosion resistant coatings, composite materials such as polymers with reinforcing carbon fiber and/or steel wire mesh for improved stiffness, strength, and ductility with optional surface preparation such as powder coating); an apertures/clearance 40A in a horizontal partition 44A of the cabinet 40 for carbon filters 80; a set of apertures/clearance 40B in a horizontal partition 44B of the cabinet 40 for various filters (pre-filter 50, primary filter 60, PCO filter 70, and carbon filter 80; an access panels 41 for maintenance, repair, and exchange of filters; an air inlet panels 42 on either side and bottom section of the cabinet 40; a set of protection screens 43 on each access panel 41; a lowest horizontal partition/floor 44 of the cabinet 40 with an external surface 44-S; a horizontal partition 44A of the cabinet 40 adjacent to the carbon filters 80; a horizontal partition 44B of the cabinet 40 adjacent to the various filters (pre-filter 50, primary filter 60, PCO filter 70, and carbon filter 80; an highest/top horizontal partition 44C of the cabinet 40 with an external surface 44C-S; an air Outlet panel 45 for purified air to exit the purification system 30 from the silencer 95 at a top location of the cabinet 40; and a group of structural components 47 of the cabinet 40 including corners, edge members, fastening means (weld, braze, threaded fasteners, pop rivets etc.

FIG. 1 C repeated is a sketch of a structure containing the components for the Ultra Fine Air Purification System and a SUBMICRON hyper-Filter 30. Three types of units are shown here.

A. SUBMICRON hyper-Filter air purifier 30. SHF-400
Best Use Case: Non-mission critical application. A great solution for odor control, VOC elimination, and air purification where HEPA level filtration is sufficient. Best fit for schools, daycares, business offices, nursing homes, art studios, and municipal facilities with high-density populations. Capacity: one air exchange per hour in a typical 2, 400 sq. ft space with 8 ft ceilings. Dimensions: 64″ H 26″ W 22″D. Max Energy Consumption: 200 Watts. Product Description: Minimal footprint; 6 stage purification; 10-speed EC fans; Marine grade aluminum construction; High performance, pressure regulating carbon cylinders; Dual HEPA filters; Proprietary baffling and specialized sound deadening materials that allow high throughput performance at incredibly low noise levels (as low as 56 dB at MAX power); and Proprietary Dual-Quad PCO filters.
   B. SUBMICRON hyper-Filter air purifier 30. SHF-800
Best Use Case: Mission-critical applications such as DOD facilities and embassies, maritime assets, barracks, surgical suits, and isolation rooms. Capacity: one air exchange per hour in a typical 6000 sq. ft space with 8 ft ceilings. Dimensions: 66″ H 26″ W 24″D. Max Energy Consumption: 300 Watts. Product Description: Minimal footprint; 6 stage purification; 10 speed EC fans; proprietary individually tested and certified hyper-Filter technology, providing an incredible ~99.999% efficiency rating; Extremely durable and rigid marine-grade, aluminum honeycomb core construction; High performance, pressure regulating carbon cylinders; Proprietary baffling and specialized sound deadening materials that allow high throughput performance at incredibly low noise levels (as low as 56 dB at MAX power); and Proprietary Dual-Quad Hellfire PCO arrays designed to last the lifetime of the unit.
   C. SUBMICRON hyper-Filter air purifier 30. SHF-1600
Best Use Case: Mission-critical applications in large spaces such as DoD facilities, maritime assets, open bay barracks, cell blocks, halls, holding areas, auditoriums, and gymnasiums. Capacity: one air exchange per hour in a typical 12000 sq. ft space with 8 ft ceilings. Dimensions: 66″ H 36″ W 30″ D. Max Energy Consumption: 400 Watts. Product Description: Minimal footprint; 6 stage purification; 10 speed EC fans; Proprietary individually tested and certified hyper-Filter technology, providing an incredible ~99.999% efficiency rating; Extremely durable and rigid marine-grade, aluminum honeycomb core construction; High performance, pressure regulating carbon cylinders; Proprietary baffling and specialized sound deadening materials that allow high throughput performance at incredibly low noise levels (as low as 56 dB at MAX power); and Proprietary Dual-Quad Hellfire PCO arrays designed to last the lifetime of the unit.

FIGS. 7 A through 7 E are more inside sketches of the UFAP system showing the internal opening or space where the carbon and PCO filters are located. This is the stack-up of the carbon filters, transitional ducting, E 10 fans and silencers for the Ultra Fine Air Purification System. These sketches show the following: a cabinet 40 Ultra Fine Air Purification System 30, the cabinet made of durable materials; pre-filter 50, primary filter 60, PCO filter 70, and carbon filter 80; a pre-filter 50, with a specification—a MERV 8 carbon pre-filters as a first level of defense and also providing a level of VOC absorption; a main/primary filter 60; a photocatalytic oxidation (PCO) filter 70; a proprietary lifetime Titanium Dioxide (TiO2) coating 77 over aluminum honeycomb 76 of the PCO filter 70; a carbon media filter 80 with an external and internal wire mesh holding granulated carbon media for the air to flow through engage said carbon; a means 81 to connect carbon filter 80 to cabinet 40 such as threaded fasteners, slots and rod, cable ties; hook and eye, snaps; and a silencer 95 for air movement and EC-10 fans 90.

FIGS. 8 A through 8 D are more sketches of an Ultra Fine Air Purification System 30 and the relationship of the containment structure and the filter system. These sketches show the corners, angles, and openings of the overall Ultra Fine Air Purification System and how the vertical stack of the carbon filter, EC 10 fans 90, and silencers 95 are placed or interposed between the other filters and components. Particularly demonstrated for an Ultra Fine Air Purification System 30 include: an inline stack-up 35 of PCO filter 70, Electronically Communicated (EC) Fans 90, lower transition ducts 91 connecting EC fans 90 to the lower PCO filter 70, upper transition ducts 92 connecting EC fans 90 to the upper silencer 95; a cabinet 40 for the Ultra Fine Air Purification System 30, the cabinet made of durable materials; a pair of access panels 41 for maintenance, repair, and exchange of filters; a lowest horizontal partition/floor 44 of the cabinet 40 with an external surface 44-S; a horizontal partition 44A of the cabinet 40 adjacent to the carbon filters 80; a PCO filter 70, a carbon filter 80; a pair of electronically Communicated (EC-10) Fans 90 or equal; and a pair of silencers 95 for air movement and EC-10 fans 90.

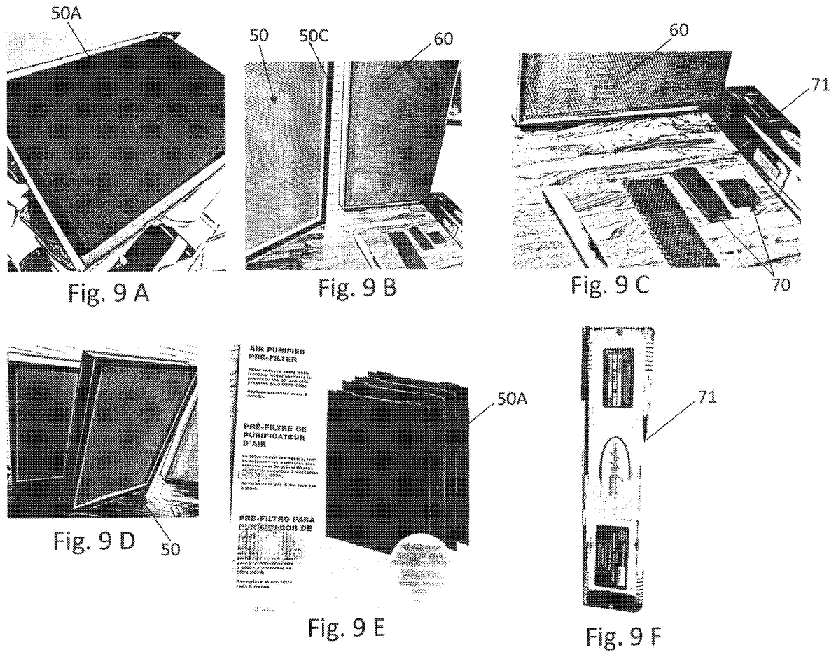

FIGS. 9 A through 9 F are sketches of the various typical filters and controllers placed into a unique combination so that the Ultra Fine Air Purification System 30 can achieve outstanding purification of the surrounding air. Here are shown components of the Ultra Fine Air Purification System 30, an air purification system having at least two/a pair/and dual filtration components with submicron hyper-filter components and six (6) stages of filtration per side; a pre-filter 50, a MERV 8 carbon pre-filters as a first level of defense also providing a level of VOC absorption, a minimum efficiency reporting value (MERV) is a rating system that measures how well an air filter traps particles in the air; a first filter media 50A for the pre-filter 50, with a specification—a MERV 8 carbon pre-filters as a first level of defense and also providing a level of VOC absorption; MERV 8 filters have 90 percent efficiency on particles that are 3 to 10 micrometers in size. MERV 1 to 4—effective at controlling larger particles such as, sanding dust, spray paint dust, lint and carpet fibers; an alternative filter media 50B for the pre-filter 50, with a specification—a MERV 12 electrostatic high-flow pre-filters are as a second or alternative level of defense; MERV 12 is an air filter rating that can trap up to 89% of particles that are 3.0-10.0 microns in size, and 80-90% of particles that are 1.0-3.0 microns in size. MERV 12 filters are often used in homes and hospitals, and are ideal for people with allergies or homes with pets; a perimeter structure 50C of the pre-filter 50 as a means for retaining the pre-filter media 50A; a retention component 51 as a means for retaining pre-filter media 50A and to interface the pre-filter 50 with the cabinet 40; a means for removably containing 53 the pre-filter 50 from the cabinet 40 such as angle iron, Tee structures, Cee channels, and the like; a main/primary filter 60; a photocatalytic oxidation (PCO) filter 70; and an electrical components and connections of circuitry, installation of cables (conductors), switches, sockets, and other control devices 71 to provide power to the PCO bulbs as well as to provide power and controls to the EC fans 90 and any control devices in the system 30.

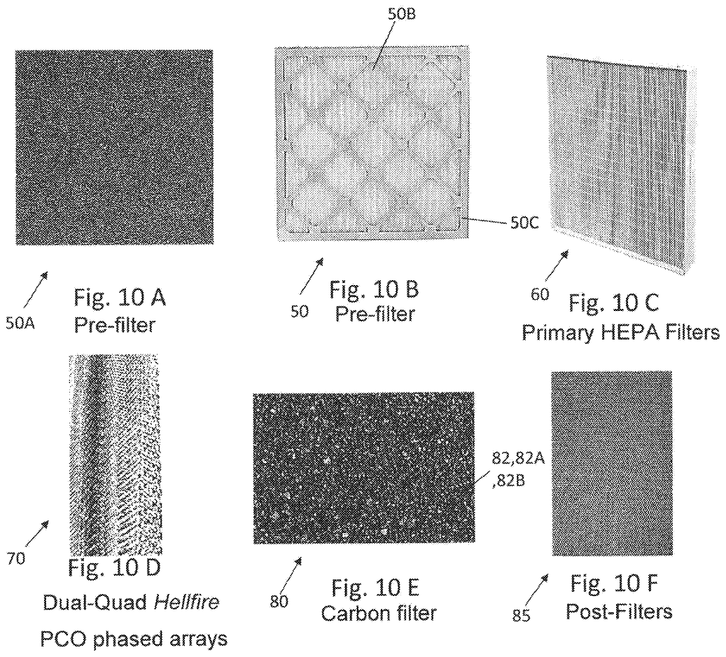

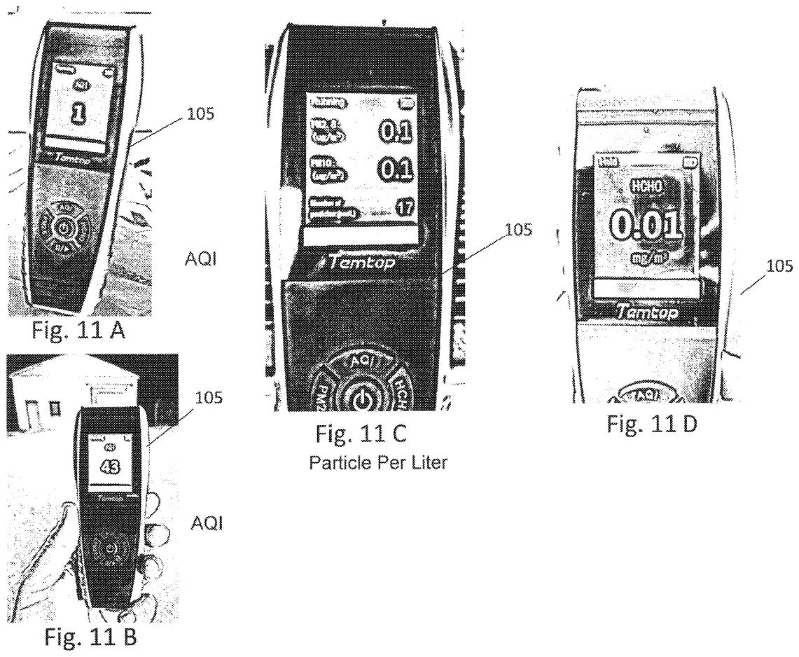

FIGS. 10 A through 10 F are sketches of typical pre-filters, main or primary HEPA filters, PCO arrays, granular carbon filters, and post filters. This combination of these filters, when placed in the containment structure, provides a new and unique combination system for air purification. The results achieved, when using the Ultra Fine Air Purification System 30 taught by inventor John Combs, demonstrate significant reduction or elimination of hazardous materials from the surrounding air and demonstrate superior air quality for the treated air. In these sketches, one sees: the various filters (pre-filter 50, primary filter 60, PCO filter 70, and carbon filter 80; a pre-filter 50, a MERV 8 carbon pre-filters as a first level of defense also providing a level of VOC absorption, a minimum efficiency reporting value (MERV) is a rating system that measures how well an air filter traps particles in the air; a first filter media 50A for the pre-filter 50; an alternative filter media 50B for the pre-filter 50, with a specification—a MERV 12 electrostatic high-flow pre-filters are as a second or alternative level of defense; a main/primary filter 60; a main filter media 60A for the main filter 60 whereby when the media 60A exceeds “high efficiency particulate air [filter]” (HEPA); a true HEPA filter or the proprietary hyper-Filters are capable of near ULPA level performance ULPA level performance at a staggering 99.999% efficiency, while still maintaining HEPA filter flow rates; a photocatalytic oxidation (PCO) filter 70; a carbon media filter 80 with an external and internal wire mesh holding granulated carbon media for the air to flow through engage said carbon; a relatively large-sized carbon granules 82 (need size or range of sizes of the granules); a relatively medium-sized carbon granules 82A (need size) (sized between 82 and 82B; a relatively small-sized carbon granules 82B (need size); and a silver impregnated post filter 85. See the Operations section below with discussion of the filter types.

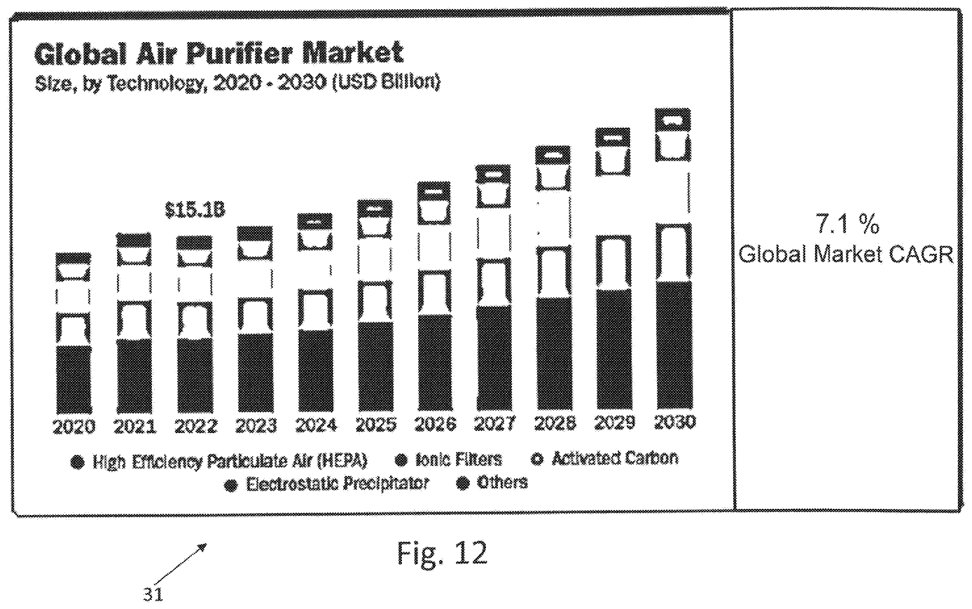

Additional information for FIGS. 10 A through 10 F filters, then FIGS. 11 A through 11 D as sketches of test indicators for reduction or elimination of targeted hazardous materials, and finally FIG. 12 as a sketch portraying the size and growth of the global market emerging for air purifier devices and air purification systems are discussed in the Operations Section, below.

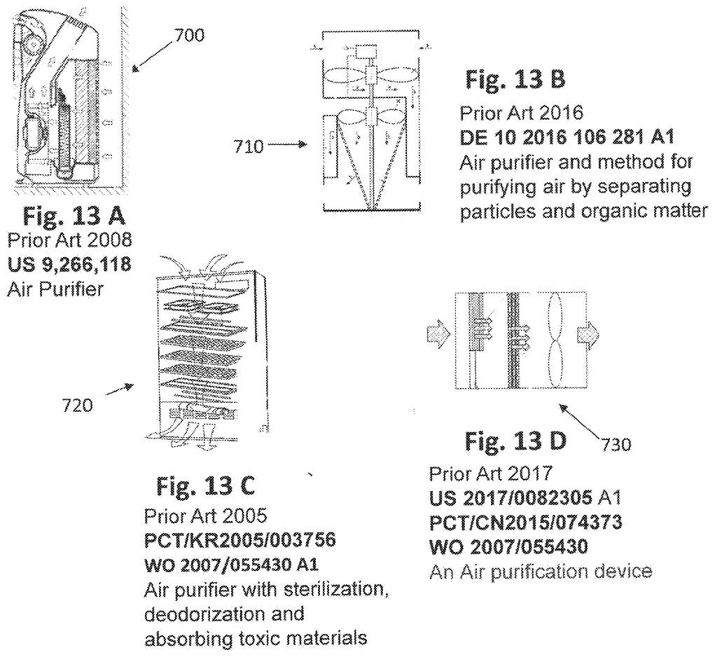

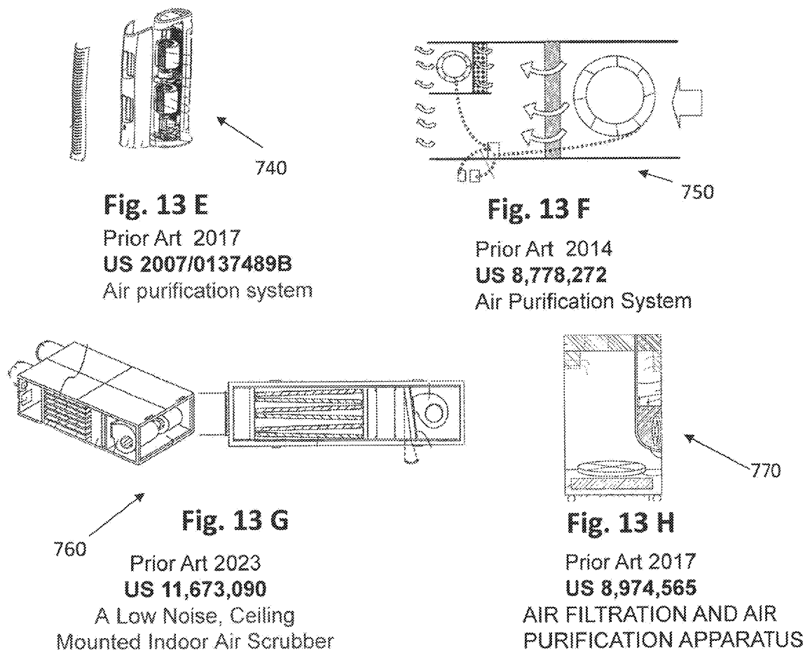

FIGS. 13 A through 13 H are sketches of prior art for air purification devices and systems. Here former patents and applications of devices and systems for Air Purification devices and systems. These devices and systems include: Prior Art 700—US Patent U.S. Pat. No. 9,266,118 by Iwaki in 2008 for an Air Purifier; Prior Art 710-German Patent DE 10 2016 106 281 A1 by Vorwerk et al. in 2016 for an Air purifier and method for purifying air by separating particles and organic material; Prior Art 720-International and Korean Patent PCT/KR2005/003756 by Bang in 2007 for an Air purifier with sterilization, deodorization and absorbing toxic materials; Prior Art 730-US Patent Application US2017/0082305 and PCT/CN2015/074373 by Law in 2017 for an Air Purifier with Sterilization, Deodorization And Absorbing Toxic Materials; Prior Art 740-US Patent U.S. Pat. No. 9,737,841 by Luo in 2007 for an Air Purifier having sterilizing Function; Prior Art 750-US Patents U.S. Pat. No. 8,778,272 by Chan in 2014 for an Air Purification System; Prior Art 760-US Patents U.S. Pat. No. 11,673,090 by Meirav et al. in 2023 for an air flow system featuring LOW NOISE, CEILING MOUNTED INDOOR AIR SCRUBBER; and Prior Art 770 US Patents U.S. Pat. No. 8,974,565 by Cecchi et al. in 2017. As can be seen, the An Ultra Fine Air Purification System 30 provides two parallel systems that utilize a six (6) stage purification system. This new combination results in a proprietary and individually tested and certified hyper-Filter technology, providing an incredible ~99.999% efficiency rating.

The materials and components shown for an Ultra Fine Air Purification System 30 and components described herein are readily available from sophisticated suppliers and vendors. The electronic control portion utilizes components and a Bluetooth/wireless system as the for communicating the status of the switches 30, 70. The device 30 can be manufactured locally in small batches for start-up and then can convert manufacturing to high volume processes when the product sales increase upon adoption by the transportation and cargo shipping industry adopts this unique combination for safety. is adopted by transportation that detects when a loose strap/tiedown event occurs and then notifies and alerts an operator/driver of the condition of the load.

The details mentioned here are exemplary and not limiting. Specific components and manners of manufacturing this configuration of an Ultra Fine Air Purification System 30 can readily be understood and adopted by a person having ordinary skill in the field of the art of purifications components, devices, and systems like described herein. This Ultra Fine Air Purification System is a unique combination of the inherent component parts for systems to operate at a peak performance when purifying the subject air.

### Operation of the Preferred Embodiment

The preferred embodiment as an Ultra Fine Air Purification System 30 having at least two/a pair/dual filtration components with submicron hyper-filter components and six (6) stages of filtration per side comprising: (a) a cabinet 40 Ultra Fine Air Purification System 30, the cabinet made of durable materials such as 5150 Marine Grade Aluminum Honeycomb, stainless steel, other durable metals with corrosion resistant coatings, composite materials configured with air inlet and exit panels, maintenance panels and casters and having a power source and electrical controls; (b) an air movement system comprised of Electronically Communicated (EC) Fans 90, lower transition ducts 91 connecting EC fans 90 to the lower PCO filter 70, upper transition ducts 92 connecting EC fans 90 to the upper silencer 95 wherein the six (6) stages of filtration per side are comprised of a set of dual pre-filters 50 with MERV 8 and MERV 12 ratings, a primary filter 60, a PCO filter 70, a PCO filter 70 with a high output (>50 Watt) T-5 UVC bulbs 75 and with a proprietary lifetime Titanium Dioxide (TiO2) coating 77 over aluminum honeycomb 76 of the PCO filter 70, and a carbon filter 80 with at least three sizes of granules.

FIGS. 10 A through 10 F are sketches of typical pre-filters, main or primary HEPA filters, PCO arrays, granular carbon filters, and post filters. This combination of these filters, when placed in the containment structure, provides a new and unique combination system for air purification. See the above description on filters. The results achieved, when using the Ultra Fine Air Purification System 30 taught by inventor John Comb, demonstrate significant reduction or elimination of hazardous materials from the surrounding air and demonstrate superior air quality for the treated air. The Pre-filters 50 are MERV 8 carbon pre-filters are the first level of defense also providing a level of volatile organic compounds (VOC) absorption. Merv 8 means the filters have 90 percent efficiency on particles that are 3 to 10 micrometers in size. MERV 1 to 4-effective at controlling larger particles such as, sanding dust, spray paint dust, lint and carpet fibers. Pre-filters with alternative filter media 50B can demonstrate as MERV 12 electrostatic high-flow pre-filters. They are the second level of defense. MERV 12 is an air filter rating that can trap up to 89% of particles that are 3.0-10.0 microns in size, and 80-90% of particles that are 1.0-3.0 microns in size. MERV 12 filters are often used in homes and hospitals and are ideal for people with allergies or homes with pets. Primary/main Filters 60 are true high-efficiency particulate air (HEPA) filter that can effectively capture and remove even the tiniest dust particles from the air. HEPA filters are highly efficient in removing airborne contaminants, making them a popular choice for those who suffer from allergies or asthma. Removing dust, allergens, and other pollutants from the air, these air purifier systems help to create a healthier and more comfortable indoor environment. HEPA filters or the proprietary hyper-Filters which are capable of near ULPA level performance at a staggering 99.999% efficiency, while still maintaining HEPA filter flow rates. HEPA—is an acronym for “high efficiency particulate air [filter]”. Dual-Quad Hellfire PCO phased arrays. Photocatalytic Oxidation (PCO) 70 is a powerful air purification technology that can destroy bacteria and viruses, as well as airborne pollutants. They incorporate the use of High output (>50 Watt) T-5 UVC bulbs 75. Also, their aluminum honeycomb 76 for the PCO filters 70 has a proprietary lifetime Titanium Dioxide (TiO2) coating 77 over aluminum honeycomb 76 of the PCO filter 70. This is a pair of post-filters and includes the layer of pure silver filaments for additional antimicrobial protection. 80 Carbon filters are high-grade carbon filters that feature a proprietary blend of activated carbon, which further removes volatile organic compounds (VOC) pollutants from the air. Post-Filters. The multiple sized granules are packed in to keep a constant airflow through the carbon granules. See the description section above for additional information in respect to the filters.

FIGS. 11 A through 11 D are sketches of test indicators 31 for reduction or elimination of targeted hazardous materials. Results found that when the air is treated by the Ultra Fine Air Purification System 30, favorable reduction or elimination of the targeted hazardous materials is achieved. Shown here are a set of Temtop air quality meter 105 or an equal air quality type etc. These sketches show a set of Temtop air quality meter 105 or an equal air quality type etc. These Temtop air quality monitors, 105 or an equal type of meter, are used to provide global users with a one-stop solution for environmental particulate matter monitoring. With a product range spanning from 0.2 μm to 100 μm, the tools are versatile and can be used in a wide range of industrial and research applications worldwide. The Temtop RTM air quality monitor can measure indexes such as: environmental particulate matter, indoor air quality, outdoor air quality, dust monitoring, micro air station, clean space, HVAC system, HCOH formaldehyde, and industrial/occupational hygiene measurements. These instruments are designed to provide the user with accurate real-time data to make informed decisions. These meters provide unparalleled performance, reliability, and accuracy for any particle monitoring challenge one faces.

Submicron air purifiers are designed and built based on clinical and Department of Defense air purification requirements, using highly advanced technologies and components. These purifiers feature a proprietary set/combination of main filters that are individually tested and serial numbered, with the individual test results provided to the customers. One additional competitive advantage includes filtration down to gaseous <. 1 micron levels, high energy efficiency, low noise levels, and quality marine and aerospace grade aluminum materials. The SUBMICRON hyper-Filter 30 is like taking two breaths in one. After an individual is exposed to a room with the Ultra Fine Air Purification System 30, that individuals blood oxygen level actually raises/increases. The submicron purifiers 30 are the only purifiers in existence shown to be so effective that they are capable of increasing blood oxygen levels.

This SUBMICRON hyper-Filter 30 unique design and proprietary technologies allow the products to achieve the most effective PCO (Photocatalytic Oxidation) filtration known to exist, helping our purifiers remove airborne contaminants down to the gaseous level. [Nuclear Biological Chemical—NBC Capable]. Durable—The SUBMICRON hyper-Filter products 30 are designed to last a lifetime. Units are constructed from corrosion-resistant marine grade aluminum, making them suitable for field or shipboard operations, and are resistant to EMP attack. A SUBMICRON hyper-Filter air purifiers feature noise levels as low as 56 decibels at MAX setting, making them suitable for occupied spaces, with the average energy consumption at full power being approximately 300 W.

FIG. 12 is a sketch/chart 31 portraying the size and growth of the global market emerging for air purifier devices and air purification systems. Shown is a Global Market Chart 31 of air purifiers called an Air Purifier Market Size & Trends. The global air purifier market size was estimated at USD 15.94 billion in 2023 and is expected to grow at a CAGR of 7.1% from 2024 to 2030. The growth is driven by rising instances of airborne diseases and pollution levels in urban areas. For instance, according to the Centre for Research on Energy and Clean Air, China experienced a rise in its national average PM2.5 level year-on-year in 2023 since the commencement of the campaign on pollution in the country. Moreover, factors such as growing health awareness, improving standard of living, and rising disposable income of the masses are expected to fuel the market growth. The rising adoption of air pollution control equipment, especially in developing regions of the world, is also anticipated to drive the growth of the air purifier industry over the forecast period.

Many uses are anticipated for the Ultra Fine Air Purification System 30. Some examples, and not limitations, of the anticipated uses are shown in the following Table.

| No. | Description of Use |
|---|---|
| 1 | Municipal facilities with high-density populations |
| 2 | Schools and daycares |
| 3 | Business offices and hallways |
| 4 | Daycares and nursing homes |
| 5 | Museums and art studios |
| 6 | Hospitals and medical care facilities, surgical |
| | suits, and isolation rooms |
| 7 | Auditoriums, gymnasiums and movie theaters |
| 8 | DoD facilities, embassies, maritime assets |
| | (shipboard and submarines), barracks |
| 9 | Cell blocks and holding areas |

With this description it is to be understood that the Ultra Fine Air Purification System 30 that detects when a loose strap/tiedown event occurs and then notifies and alerts an operator/driver of the condition of the load. The features of the present Ultra Fine Air Purification System 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted as coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. An air purification system comprising: a cabinet comprising a marine-grade aluminum honeycomb enclosure having at least one air inlet panel, at least one air outlet panel, at least one access panel, and a plurality of casters providing portability; at least two parallel filtration assemblies disposed within the cabinet, each filtration assembly comprising six sequential filtration stages; and an air movement assembly associated with each filtration assembly, the air movement assembly comprising a variable-speed electronically commutated (EC) fan, lower transition ducting connecting the EC fan to a lower photocatalytic oxidation (PCO) filter assembly, and upper transition ducting connecting the EC fan to a silencer assembly coupled to the air outlet panel; wherein the six sequential filtration stages of each filtration assembly comprise, in order of airflow: a first stage comprising a MERV 8 carbon pre-filter; a second stage comprising a MERV 12 electrostatic pre-filter disposed downstream of the first stage; a third stage comprising a primary submicron filter having a filtration efficiency of at least approximately 99.999% disposed downstream of the second stage; a fourth stage comprising a photocatalytic oxidation (PCO) filter assembly disposed downstream of the third stage, the PCO filter assembly comprising at least one ultraviolet-C (UVC) light source having an output greater than 50 Watts, at least one high-reflectivity reflector, an aluminum honeycomb substrate, and a titanium dioxide (TiO2) catalytic coating applied over the aluminum honeycomb substrate; a fifth stage comprising a granular activated carbon filter disposed downstream of the fourth stage, the carbon filter containing activated carbon granules in at least three distinct granule size ranges; and a sixth stage comprising a silver-impregnated post-filter disposed downstream of the fifth stage.

2. The air purification system of claim 1, wherein the cabinet is constructed of 5150 Marine Grade Aluminum Honeycomb.

3. The air purification system of claim 1, wherein the primary submicron filter of the third stage is a hyper-Filter individually tested and serial-numbered achieving approximately 99.999% filtration efficiency while maintaining airflow rates consistent with HEPA filtration standards.

4. The air purification system of claim 1, wherein the UVC light source comprises a T-5 UVC lamp rated at greater than 50 Watts.

5. The air purification system of claim 1, wherein the titanium dioxide (TiO2) catalytic coating of the fourth stage is a lifetime coating configured to provide permanent catalytic activity for the operational service life of the air purification system without scheduled replacement.

6. The air purification system of claim 1, wherein the at least one high-reflectivity reflector comprises a high-density German aluminum reflector configured to redirect UVC photons back through the titanium dioxide catalytic coating to maximize photon utilization and catalytic surface activation.

7. The air purification system of claim 1, wherein the activated carbon granules in at least three distinct granule size ranges comprise: relatively large-sized carbon granules; relatively medium-sized carbon granules having dimensions intermediate between the large-sized granules and small-sized granules; and relatively small-sized carbon granules; wherein the at least three granule size ranges are packed within the carbon filter to provide pressure regulation across a carbon bed to prevent channeling and maintain uniform airflow distribution.

8. The air purification system of claim 1, wherein the variable-speed electronically commutated (EC) fan provides at least ten discrete operational speed settings.

9. The air purification system of claim 1, further comprising baffling and sound-deadening materials within the cabinet and silencer assembly configured to achieve an operational noise level of no greater than 56 decibels (dB) at maximum fan speed.

10. The air purification system of claim 1, wherein the sixth stage silver-impregnated post-filter comprises a layer of pure silver filaments configured to provide antimicrobial activity via ionic silver release against bacteria, mold, and fungi in the purified airstream.

11. The air purification system of claim 1, wherein the primary submicron filter of the third stage is sealed to the cabinet by dovetailed gaskets comprising Poron foam, and is retained by a retention component and removable by a means for removably containing comprising at least one of an angle iron, a T-channel structure, or a C-channel structure.

12. The air purification system of claim 1, wherein the photocatalytic oxidation filter assembly is configured as a Dual-Quad phased array comprising four UVC lamp positions per filtration assembly and corresponding reflectors arranged to provide substantially uniform UVC irradiation across the aluminum honeycomb substrate.

13. The air purification system of claim 1, wherein the cabinet further comprises at least one horizontal partition having apertures sized and positioned to receive and locate the carbon filter of the fifth stage, and at least one additional horizontal partition having apertures sized and positioned to receive and locate at least one of the first stage, second stage, third stage, and fourth stage filter elements.

14. The air purification system of claim 1, wherein the air purification system achieves filtration of airborne contaminants to submicron and gaseous-phase levels below 0.1 micron, including Nuclear-Biological-Chemical (NBC) class purification of airborne pathogens, VOCs, and chemical agents.

15. The air purification system of claim 1, further comprising at least one of: a humidifier coupled to the air outlet panel; a dehumidifier coupled to the air outlet panel; or a scent distributor coupled to the air outlet panel.

16. The air purification system of claim 1, wherein the MERV 8 carbon pre-filter of the first stage comprises activated carbon integrated into filter media to provide volatile organic compound (VOC) adsorption simultaneous with coarse particulate capture.

17. The air purification system of claim 1, wherein the cabinet is resistant to electromagnetic pulse (EMP) by virtue of the marine-grade aluminum honeycomb enclosure construction.

18. The air purification system of claim 1, wherein the air purification system is configured in a first embodiment providing airflow coverage of approximately one air exchange per hour for a space of approximately 2,400 square feet at 8-foot ceiling height with a maximum energy consumption of approximately 200 Watts.

19. The air purification system of claim 1, wherein the air purification system is configured in a second embodiment providing airflow coverage of approximately one air exchange per hour for a space of approximately 6,000 square feet at 8-foot ceiling height with a maximum energy consumption of approximately 300 Watts.

20. The air purification system of claim 1, wherein the air purification system is configured in a third embodiment providing airflow coverage of approximately one air exchange per hour for a space of approximately 12,000 square feet at 8-foot ceiling height with a maximum energy consumption of approximately 400 Watts.

21. A method of purifying air comprising: drawing ambient air into a portable cabinet housing at least two parallel filtration assemblies through at least one air inlet panel by operation of at least two variable-speed electronically commutated (EC) fans; passing the ambient air sequentially through six filtration stages of each filtration assembly, comprising: capturing coarse particulates and adsorbing volatile organic compounds in a first MERV 8 carbon pre-filter stage; capturing fine particulates electrostatically in a second MERV 12 pre-filter stage; removing submicron particulates at approximately 99.999% efficiency in a third primary submicron filter stage; destroying bacteria, viruses, mold, and gaseous-phase chemical contaminants by photocatalytic oxidation in a fourth stage comprising irradiating a titanium dioxide catalytic coating on an aluminum honeycomb substrate with ultraviolet-C light of greater than 50 Watts in the presence of high-reflectivity aluminum reflectors; adsorbing residual volatile organic compounds and gaseous pollutants by contact with activated carbon granules in at least three distinct size ranges in a fifth carbon filter stage; and providing antimicrobial protection via silver ion activity in a sixth silver-impregnated post-filter stage; attenuating fan and airflow noise through at least one silencer assembly; and discharging purified air through an air outlet panel at an operational noise level of no greater than 56 decibels at maximum fan speed.

22. The method of claim 21, wherein drawing ambient air further comprises drawing air through air inlet panels positioned on lateral sides and a bottom section of the cabinet simultaneously.

23. A portable air purification system comprising: a structurally rigid cabinet constructed of marine-grade aluminum honeycomb and mounted on casters; dual parallel air filtration paths housed within the cabinet, each air filtration path comprising six sequential filtration stages and an electronically commutated fan providing variable-speed airflow through the six stages; a first stage MERV 8 carbon pre-filter; a second stage MERV 12 electrostatic pre-filter; a third stage submicron primary filter having approximately 99.999% filtration efficiency; a fourth stage photocatalytic oxidation filter comprising high-output UVC lamps exceeding 50 Watts, high-reflectivity aluminum reflectors, and a lifetime titanium dioxide catalytic coating on an aluminum honeycomb substrate; a fifth stage granular activated carbon filter comprising activated carbon in at least three distinct granule size ranges providing pressure-regulating airflow through the carbon bed; and a sixth stage silver-impregnated post-filter; wherein the system achieves operational noise levels of no greater than 56 dB at maximum fan speed.

24. An Ultra Fine Air Purification System (30) having at least two/a pair/dual filtration components with submicron hyper-filter components and six (6) stages of filtration per side comprising:
(a) a cabinet (40) Ultra Fine Air Purification System (30), the cabinet made of durable materials such as 5150 Marine Grade Aluminum Honeycomb, stainless steel, other durable metals with corrosion resistant coatings, composite materials configured with air inlet and exit panels, maintenance panels and casters and having a power source and electrical controls;
(b) an air movement system comprised of Electronically Communicated (EC) Fans (90), lower transition ducts (91) connecting EC fans (90) to the lower PCO filter (70), upper transition ducts (92) connecting EC fans (90) to the upper silencer (95)
wherein the six (6) stages of filtration per side are comprised of a set of dual pre-filters (50) with MERV 8 and MERV 12 ratings, a primary filter (60), a PCO filter (70), a PCO filter (70) with a high output (>50 Watt) T-5 UVC bulbs (75) and with a proprietary lifetime Titanium Dioxide (TiO2) coating (77) over aluminum honeycomb (76 of the PCO filter (70), and a carbon filter (80) with at least three sizes of granules.
